(19) United States
(12) Patent Application Publication
(10) Pub. No.: US 2021/0126854 A1
(43) Pub. Date: Apr. 29, 2021

(54) TCP PERFORMANCE MODEL BASED IN-BAND NETWORK TELEMETRY

(71) Applicant: Arista Networks, Inc., Santa Clara, CA (US)

(72) Inventors: Xiangyi Guo, San Jose, CA (US); Wei Dai, San Jose, CA (US); Udayakumar Srinivasan, Fremont, CA (US); James Michael Murphy, Alameda, CA (US)

(21) Appl. No.: 16/853,486

(22) Filed: Apr. 20, 2020

Related U.S. Application Data
(60) Provisional application No. 62/925,193, filed on Oct. 23, 2019.

(51) Int. Cl. H04L 12/707; H04L 12/741; H04L 12/26; H04L 12/851; H04L 29/06; H04L 12/28

(52) U.S. Cl. CPC H04L 45/24; H04L 45/22; H04L 45/54; H04L 43/0829; H04L 2212/00; H04L 47/2441; H04L 69/163; H04L 12/2854; H04L 43/087

(57) ABSTRACT

Systems and methods for a path selection by a network router are disclosed. The router receives a data packet destined to travel a current path, as identified by a packet header, to a destination router. The router determines whether the current path is the best path of a set of network paths for the data packet to travel to reach the destination router based on telemetry characteristics of a set of network paths. The telemetry characteristics include a bandwidth availability estimate that is a function of one or both of a corresponding path throughput and a corresponding path packet loss rate. In response to determining the current path is not the best path, the router chooses a best path based on the telemetry characteristics of the set of paths and replaces the current path with the best path for travel by the data packet to the destination router.

### CROSS-REFERENCE TO RELATED APPLICATIONS

This application claims priority to U.S. Provisional Application No. 62/925,193 filed on Oct. 23, 2019, and titled “TCP Performance Model-Based Band Network Telemetry,” by Guo et al., incorporated by reference herein as though set forth in full

### BACKGROUND

The present disclosure relates to load balancing in computer networks.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is an illustrative block diagram of a wide area network (WAN) network system, in accordance with some embodiments of the disclosure;

FIG. 2 is an illustrative block diagram of an example leaf-spine network topology, in accordance with some embodiments of the disclosure;

FIG. 3 is an illustrative block diagram of an edge router, in accordance with some embodiments of the disclosure;

FIG. 4 is a flowchart of a method for traffic class-based path flow selection process, in accordance with some embodiments of the disclosure;

FIG. 5 is an illustrative block diagram of a router, in accordance with some embodiments of the disclosure;

FIG. 6A shows an example PTS header structure, in accordance with some embodiments of the disclosure;

FIGS. 6B and 6C each show an example of a PTS header structure, in accordance with some embodiments of the disclosure;

FIG. 7 shows a computing system implementation, in accordance with some embodiments of the disclosure;

FIG. 8 shows an example WAN-based network implementation, in accordance with some embodiments of the disclosure; and

FIGS. 9 and 10 each show a flowchart of a network path selection process, in accordance with some embodiments of the disclosure.

### DETAILED DESCRIPTION

Measuring network path characteristics, “telemetry,” can help offer valuable insight into the performance of networking systems. Awareness of network path characteristics, such as latency, jitter, packet loss rate and bandwidth availability, can yield better traffic load balancing. Current traffic congestion control techniques are limiting. They can leave out vital information like in-band data metrics, which is data intended for transmission between networks. Performance characteristics of network paths carrying in-band data can prove vital to effective network path selection and traffic load balancing. Besides, measuring out-of-band data path characteristics typically necessitates generating extra traffic to ensure measurement reliability, leading to increased network traffic. An example is ping data where out-of-band data is pinged back and forth between hosts while measuring transmission and return times for latency and packet loss rate determinations. Insufficient ping traffic can lead to packet loss; therefore, a monitored network must be interjected with heavy out-of-band traffic to effect reliable performance metrics. Even more ping traffic may be required, at times, based on the class of traffic. For example, transmission control protocol (TCP)-compliant congestion control measurements can necessitate inserting TCP markers into ping traffic.

Another known telemetry measurement technique is traffic flow sampling, where characteristics of network traffic samples are measured using a centralized controller, a costly and arduous process, at times yielding inaccurate and unreliable results.

Noteworthy in all the foregoing techniques, while latency and packet loss may be measured, bandwidth availability measurements are lacking. Without the benefit of bandwidth predictability, applications executing on a network cannot be evaluated effectively as to performance, and application execution cannot be optimized. Bandwidth awareness warns of potential upcoming path traffic congestion and bottlenecks, providing the opportunity to avoid traffic congestion through intelligent path selection.

When applied to network performance, telemetry can help facilitate effective load balancing. Knowledge of network congestion based on path characteristics, such as jitter, latency, packet loss rate, and bandwidth availability, can be applied to achieve dynamic path selection based on the least congested network paths and/or nodes. In an embodiment, path characterization is at least partly based on weighted round robin (WRR), in addition to path characterization measurements, to decide a service-class path prioritization.

In accordance with some disclosed embodiments and methods, a network router selects the best path, an optimal path, among the available paths for a data packet to travel to a destination router based on path characteristics. In some embodiments, the router is network traffic class-aware. That is, different classes (e.g., voice, data) of network traffic can be mapped to different path telemetry sessions for obtaining path characteristics per traffic class. While existing protocols (e.g., TCP, datagram congestion control protocol (DCCP)) are designed to support congestion avoidance for host-to-host communications, some embodiments of the disclosure employ TCP-like mechanisms to find path characteristics between routers in a network for the purposes of path selection and quality of service. For example, a disclosed network router may be network traffic class-aware. Different classes (e.g., voice, data) of network traffic can be mapped to different path telemetry sessions for path characteristics knowledge on a per traffic class basis.

In some embodiments, a router policy-based routing (PBR) engine monitors one or more telemetry characteristics of a set of paths visible to the router. The PBR engine may monitor the path telemetry characteristics in real time for current route awareness and improved path optimization. When a data packet, including a header with a destination router address, is received at an ingress interface of the network, the router determines whether the path currently selected for the data packet to travel to reach the destination router is a best path among the monitored paths. In the case where the router determines that the current path is not the best path, the router replaces the current path with a selected best path based on the monitored path characteristics, and the data packet travels the selected path to reach the destination router. In some embodiments, the selected path is the best path based on the path telemetry characteristics of the monitored network paths. In the case where the router determines the current path is the best path, the current path remains the path the data packet is destined to travel to reach the destination router, and no path interference is performed by the router. In some embodiments, when selecting the best path, the router monitors characteristics of the current path and performs measurements based on the monitored telemetry characteristics for comparison with telemetry characteristics of the monitored paths.

In the case where the router replaces the current path with the selected best path, the data packet may be encapsulated with a path telemetry and shaping (PTS) header to indicate the selected best path and overriding the current path. The router transmits the encapsulated data packet through an egress interface of the network for travel to the destination router. The monitored characteristics of the set of paths from which the router selects a path from may be based on a path latency, jitter, packet loss, bandwidth, or a combination of the foregoing path characteristics. The router may rely on yet other suitable path characteristics to select a best path. In some embodiments, a path telemetry header, such as a PTS header, carries a port number that can support multiple telemetry sessions per path.

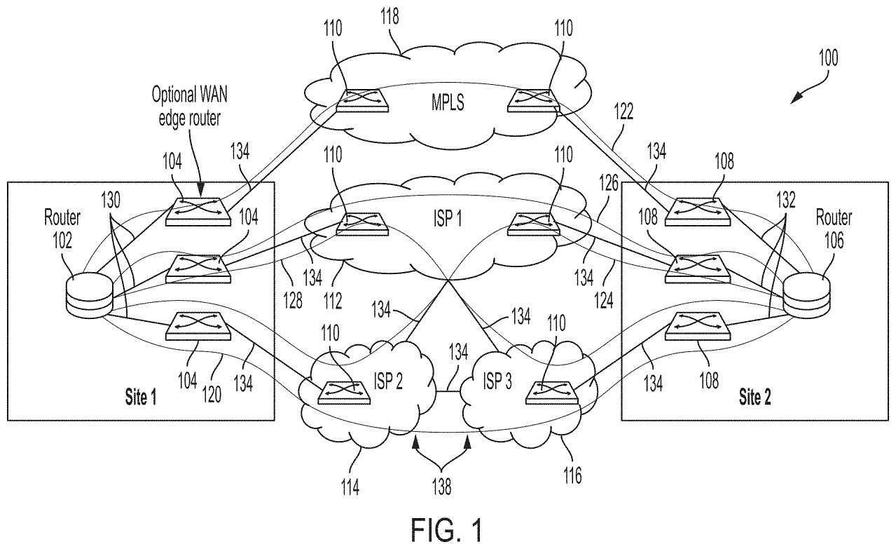

Consider a wide area network (WAN) network system, such as a WAN network system of FIG. 1. FIG. 1 is a conceptual diagram of a WAN network system 100. The data packets of system 100 are made to selectively travel multiple WAN paths and nodes connecting two WAN network sites, Site 1 and Site 2. While FIG. 1 shows two network sites with specific numbers of network elements (nodes), network paths (links), and subnets, it is understood that network topologies other than WAN and/or made with a different combination of nodes and links, e.g., greater or fewer number of subnets, routers, and switches than shown in FIG. 1, may be employed and can enjoy similar dynamic path selection and load balancing outcomes, as those discussed herein.

Each of Site 1 and Site 2 includes a host (for example, server) that transmits network packets to and receives network packets from one of several optional WAN edge routers (nodes) and through one of several network paths (links) based on traffic congestion. Site 1's host is a host router 102, and Site 2's host is a host router 106. Data packets from a site host (node) are routed, by a respective transmitting WAN edge router, traveling through one of the subnet paths, 118, 112, and 138, before being received by a receiving WAN edge router and routed to a host router (on the opposite site). In the example of FIG. 1, one of the edge routers 104, at Site 1, may be selected to route a data packet from host 102, through a WAN subnet path, to be received by one of the edge routers 108 of Site 2 and ultimately by destination host 106. A data packet can, therefore, travel through many combinations of several nodes and links in FIG. 1 prior to reaching its final destination. Disclosed dynamic path selection processes and techniques determine an optimized path to achieve load balance. For example, a data packet chartered to travel a congested path, one that is predicted to have bandwidth bottleneck, is redirected to a path with no predicted bandwidth bottleneck.

In some cases, path selection is based on path characterization in addition to the class of traffic. For example, for voice traffic, an example of critical traffic, the least latency fraught path may be selected, whereas, for video streaming traffic, such as from YouTube, non-critical traffic, latency may be a characteristic of comparatively less significance and a jitter-minimized path may be a more suitable option.

As earlier indicated, in FIG. 1, three subnets 118, 112, and 138 provide various path options for a traveling data packet between Sites 1 and 2. Each subnet includes a combination of network elements (nodes) and links and two switches 110. A subnet may have a variety of network elements and/or a different number of network elements and paths than those shown in FIG. 1, based on a designer's topology preferences.

In an example topology, subnet 118 is a multiprotocol label switching (MPLS) network, subnet 112 is an internet service provider (ISP) network, and subnet 138 comprises two subnets (ISP 2) 114 and (ISP 3) 116, each including a switch 110 and both connected to each other through a link 134. Links connecting nodes within Site 1 are labeled 130, links connecting nodes within Site 2 are labeled 132, and links connecting site nodes and subnet nodes are labeled 134 in FIG. 1A. Exemplary data packet travel paths between Sites 1 and 2, through subnets 118, 112, and 138, are labeled paths 120, 122, 124, 126, and 128. It is understood that a data packet may travel paths not shown in FIG. 1 and discussed herein.

In an exemplary congestion control path selection process, an audio network packet, originating from Site 1 host 102, can travel through path 126 and one of the three transmitting WAN edge routers 104, onto and through nodes and links of subnet 112 (ISP1), be received by one of three receiving WAN edge routers 108 at Site 2, ultimately routed to Site 2 host 106 to experience the least congested path, at the time of travel, based on certain path characteristic factors. Data packets originating from Site 2 host can similarly travel the least congested path and nodes to reach their destination at Site 1 host. Additionally, data packets can be dynamically steered through and within the least congested subnet to avoid heavy network traffic effects.

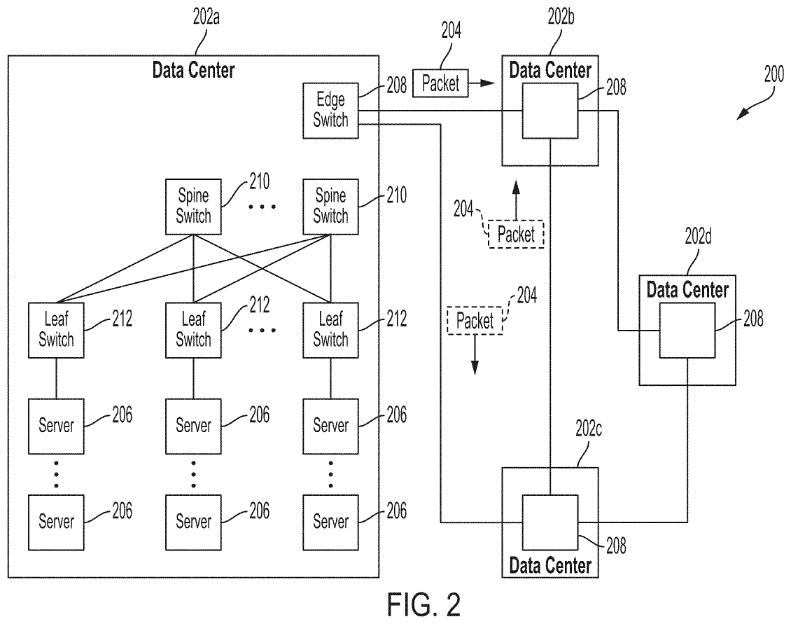

In a leaf-spine network topology 200, shown at FIG. 2, data packets 204 may take different paths, based on traffic intensity, to travel from one data center 202a to a final destination data center 202d. Data packet 204 may travel through one or multiple data centers, data centers 202b, 202c, and networks, or one large extended network, between data centers 202a and 202d. As shown by the packets 204 with dashed outlines, in many cases there are more than one path from data center 202a to destination data center 202d, just as there are often more than one path from one node to another node within a data center, such as data center 202a. In this depiction, data center 202a has multiple routers or switches, such as a pair of spine switches 210, three leaf switches 212, an edge switch 208, and multiple servers 206 servicing the various spine and leaf switches. Servers 206 communicate with the leaf switches 212, which in turn communicate with the spine switches 210. Spine switches 210 transmit data from leaf switches 212 to edge switch 208. It is understood that the configuration of network elements in data center 202a is but a non-limiting example of numerous possible arrangements. While not shown, data centers 202b-c may also include one or more routers, switches, servers, and other types of network elements. Further arrangements of routers and switches located inside or outside of data centers 202a-202d are readily devised, in FIG. 2. For example, each data center 202 may have at least one edge switch; for example, data center 202a is shown to include edge switch 208, which routes packets to other data centers 202b or 202c along inter-data center links and is responsible for detecting when a particular path from one data center, for example, data center 202a, to another data center, for example, data center 202b, e.g., from one node to another, is up or down.

In each network configuration of FIGS. 1 and 2, path characterization may be performed at the transport layer (layer 3) from network element to network element, e.g., router-to-router. In both FIG. 1 and FIG. 2 network topologies, all network paths are continually monitored to broaden the search for a best-path determination. In addition to jitter, latency, packet loss rate, and bandwidth availability measurements, path characteristic measurements can be based on the particular application being executed. For example, path 126, in FIG. 1, may be experiencing the least packet loss rate with the highest bandwidth availability among remaining paths and, therefore, best suited for a voice-over-internet-protocol (VoIP) application while path 122 may be selected based on the least-jitter characteristic and therefore selected for a video streaming application execution.

In both FIG. 1 and FIG. 2 network topologies, costs for sending a network packet, for example, in FIG. 2, packet 204, in terms of bandwidth, speed, distance, latency, number of hops (travel between nodes) or other physical constraints, and monetary value, may not be the same over various paths. In some embodiments, policy-based routing supports the use of traffic classification in the packet to indicate a traffic class priority that may dictate the path to be traveled, according to a corresponding network edge router. For example, a background task could be designated a lower-priority traffic class than a hypertext terminal protocol (HTTP) request, or audio or video streaming, which would have higher-priority traffic classification. With policy-based routing, depending on the traffic class, a router or switch can send a packet in one hop, or two or three hops, from a source to a destination, e.g., as specified by a destination internet protocol (IP) address.

Accordingly, path characteristics measurement methods and embodiments facilitate network performance awareness, load balancing, application execution improvement, bandwidth bottleneck prevention, and/or traffic congestion avoidance. Path characteristics can be different for distinct classes of network traffic. Measured characteristics for different traffic classes, in the same network path, can be employed by a network system to dynamically choose paths in accordance with different traffic, i.e., treating different network traffic classes differently, improving load balancing and cost-effectiveness. In this respect, applications with critical traffic experience higher-quality intra- and inter-network data transmission.

In some embodiments, a header-encapsulated network packet carries network path metrics for path characterization and, in some cases, class priority. For example, packet sequence numbers may be embedded in a header packet, encapsulating a corresponding original packet (which may itself have an associated header), for computing packet loss. An acknowledgment packet time stamp in the header packet encapsulating the original network packet can be compared to a current time stamp to compute round-trip time (RTT). In an embodiment, bandwidth availability prediction can be calculated based on packet loss rate and RTT.

In a disclosed method, in-band TCP network path bandwidth availability estimation is determined at the (layer 3) network layer, for example, router-to-router, using TCP performance characteristic modeling. A TCP performance model algorithm, such as the one disclosed in “The Macroscopic Behavior of the TCP Congestion Avoidance Algorithm,” by Matthew Mathis et al., published in July 1997, and found at http://ccr.sigcomm.org/archive/1997/ju197/ccr-9707-mathis.pdf, may be implemented to determine network path bandwidth availability. Bandwidth availability estimation can avoid otherwise performance-degrading bandwidth bottlenecks, optimize load balancing, and improve customer application execution efficiency. As will be further discussed, dynamic path selection entails selecting a path between two distinct types of network paths, i.e., multi-protocol label switching (MPLS) and internet service provider (ISP), in a WAN-to-WAN network configuration, or a public cloud topology, to improve load balancing, a cost-effective measure.

Pursuant to the foregoing TCP performance model, network throughput may be calculated as follows:

$$\begin{matrix}X = \frac{1}{RTT * f ( p )} & Eq . 1 \\ f ( p ) = \sqrt{\frac{2 p}{3}} + 12 * \sqrt{\frac{3 p}{8}} * ( p + 32 * {p}^{3} ) & Eq . 2\end{matrix}$$

where “X” represents throughput in bits per second, “p” represents packet loss rate, and “RTT” represents round-trip time. Packet loss and RTT may be determined in several ways, one of which is sequencing and use of time stamp, respectively, as will be discussed further below. Network throughput, “X,” is an effective measure of a network path bandwidth availability.

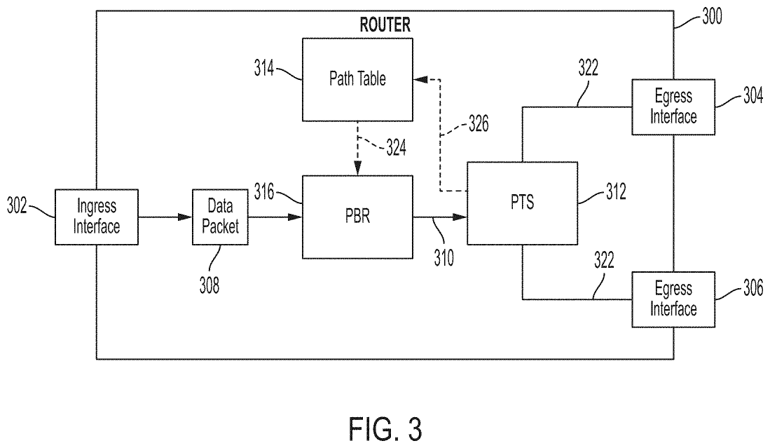

FIG. 3 shows an example edge router 300 that may be employed in the examples of FIGS. 1-2, receiving ingress network traffic at interface 302 (of the network) and transmitting egress network traffic through one of the egress interfaces 304 and 306 (of the network). Router 300 includes path telemetry and shaping (PTS) module 312, which performs path telemetry monitoring in accordance with disclosed techniques for monitoring and measuring characteristics of all available network paths that make their way to router 300. Router 300 further includes a path table 314 and a policy-based routing engine (PBR) 316, collectively implementing dynamic path selection based on ongoing monitoring of all active network paths through router 300 by PTS module 312.

In an example embodiment, router 300 receives local area network (LAN) traffic through ingress interface 302 and transmits WAN traffic through egress interfaces 304, 306. PBR engine 316 receives packets of traffic, for example, data packet 308, and selects a best-characterized path for the received packet and transmits the packet, along with the best path information, to PTS engine 312. In some cases, the current path designated for data packet 308 travel to a destination network device may remain the same, and data packet 308 is transmitted through egress interfaces 304 or 306 with no path interference because the current path may indeed be the best path. Whereas, in some cases, the current path may be replaced by a selected best path, a path different from the current path, therefore changing the originally selected path travel for data packet 308 to the destined network device.

In an embodiment, PBR 316 reads 324 internet protocol (IP) addresses from path table 314, and, based on maintained addresses in path table 314, PBR engine 316 decides on the best path. PTS engine 312 may upgrade the path of the packet, provided by PBR engine 316, by implementing a PTS header. That is, PTS engine 312 encapsulates data packet 308 with the PTS header and transmits the encapsulated packet out of router 300 through one of the WAN interfaces 304 and 306. For best path selection at any given time, PTS engine 312 continuously monitors network traffic. In an embodiment, PTS engine 312 monitors network traffic by measuring certain path characteristics of all WAN traffic that travels through router 300. To this end, router 300 may receive packets of multiple paths through a single interface, such as ingress interface 302, or it may receive packets of multiple paths through more than one interface. The network may include a different number of egress interfaces from those shown in FIG. 3. For example, for faster throughput, the network may include more than two egress interfaces, whereas cost mindfulness may be better achieved by the use of one egress interface.

In some embodiments, PTS engine 312 awaits a response (DataACK (or ACK) packet) to a transmitted packet through a monitored path and measures path characteristics of the monitored path based on the transmitted and responsive packets, for example, the time of arrival of the ACK packet. PTS engine 312 may send a packet through one of the interfaces 304, 306, and a selected network path, and upon receiving an ACK packet in response to sending the packet, measure the path RTT. PTS engine 312 may do so continually or periodically based on network traffic intensity, executing application type, or other suitable criteria. In an embodiment, PTS engine 312 monitors network traffic in real time. In an embodiment, PTS engine 312 may monitor network traffic offline or not in real time by using a buffer scheme.

PTS engine 312 writes (or stores) 326 measured path characteristics in path table 314. Path table 314 may be a lookup-table or a link list, or may be made of volatile, nonvolatile, cache, or database types of storage, among other suitable storage types. As earlier noted, PBR engine 316 uses the contents of path table 314, which is based on monitored paths by PTS engine 312, to determine the best path, a path with the best characteristics based, for example, on network traffic class. In an embodiment, based on an accumulation of current path characteristics for all available paths in path table 314, PBR engine 316 determines the best path for a new data flow.

Relative to path selection, a network path exhibiting the lowest jitter effects but lacking in that it has some latency may nevertheless qualify as the best path for video streaming, whereas, the opposite may be the case for voice traffic, in that the best-qualified path may be one with the least latency characteristic yet tolerably higher jitter effects.

In an embodiment, PBR engine 316 may skip a best-path determination. For example, in the face of an existing data flow, PBR engine 316 may not select a path based on path characteristics, as measured by PTS engine 312. As earlier noted, ultimately, the best path determination may be made by PBR engine 316 based on the class of traffic received by router 300. In an embodiment, PBR engine 316 may use a combination of policy-based route decisions and measured path characteristics from PTS engine 312 to decide the best path. In yet another embodiment, PBR engine 316 may receive policy-based route information or determinations in combination with measured or computed network path characteristics to formulate a path decision.

In an embodiment, one or more of router 300 ports (interfaces), such as the port at interface 304, may be a dedicated priority port, exclusively devoted to critical traffic. Router 300 may implement weighted round robin (WRR) to queue traffic. That is, router 300 utilizes PBR engine 316 to classify various service classes such as real time, interactive, and file transfer, to assign a queue that is specifically dedicated to that service class. Critical service-class traffic is queued at the port of interface 304, whereas non-critical service-class traffic is queued at the port of interface 306, for example.

In an embodiment, path table 314 is part of routing or forwarding tables, memory, storage, or a combination thereof. In an embodiment, path table 314 is a stand-alone table, memory, storage, or a combination thereof. In an embodiment, path table 314 is a part of PTS engine 312, and in an embodiment, path table 314 resides externally to PTS engine 312. In an embodiment, path table 314 is a part of PBR engine 316, and in an embodiment, path table 314 resides externally to PBR engine 316.

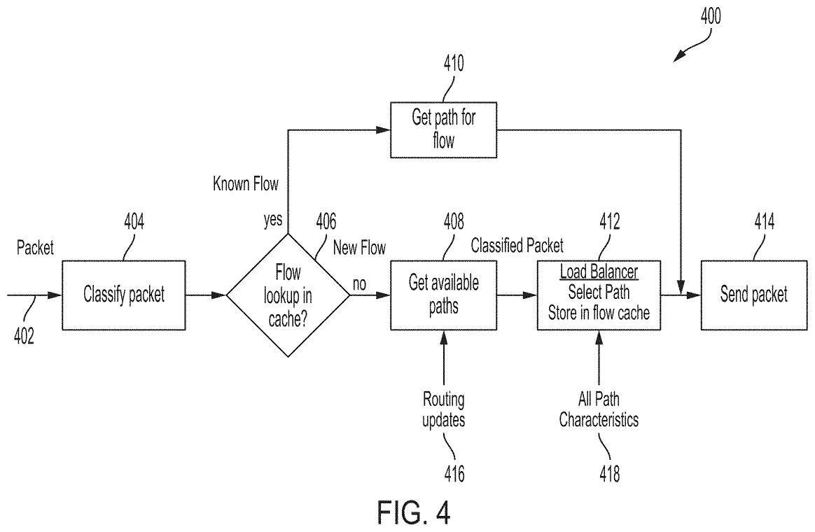

FIG. 4 is a flow diagram of a method for traffic class-based path flow selection in a network, which can be practiced by embodiments of the networks and router shown in FIGS. 1-3. In an embodiment, the flow diagram of FIG. 4 describes a process performed by an edge router. In some embodiments, the method can be performed by software executing on a processor, and in some embodiments, the method is further performed using a content-addressable memory. In an embodiment, the steps and determinations shown in FIG. 4 are performed by a network router, such as, without limitation, router 300. The flow diagram of FIG. 4 is described below, relative to router 300 of FIG. 3.

With reference to FIG. 4, at block 404, PBR engine 316 determines the class of network traffic based on the header information of an incoming network packet 402. Network traffic class, such as voice data, is queued as critical traffic. Video data may be queued as non-critical traffic. Critical traffic may be given priority over non-critical traffic and transmitted ahead of non-critical traffic. PBR engine 316 may make a best-path determination based on a combination of network traffic class and network path characteristics received from PTS engine 312. PTS engine 312 monitors characteristics of all paths (at 418 in FIG. 4) and writes the monitored characteristics in a path table as earlier described.

Next, at determination block 406, PBR engine 316 decides as to whether the current path, through which packet 402 is traveling, is in cache memory, or not. IP addresses of current paths may be stored in cache memory for faster access. Cache memory may be a part, or all, of the path table, such as path table 314, or a part of another type of table. If the determination at 406 yields the path exists, the process continues to block 410 where the existing path flow, identified by IP addresses, is retrieved from memory or storage, and the process continues to block 414 where the packet is sent. Otherwise, the process continues from determination block 406 to block 408, where all available paths are determined based on routing updates 416. Routing updates 416 reflect recent changes to existing paths. For example, a failed network element may result in a path change requiring a packet to travel through one or more different network elements. Routing updates 416 are also reflective of network traffic classification, as earlier indicated. In an embodiment, routing updates 416 are maintained in path table 314 or other path mapping or forwarding tables.

Following block 408, at block 412, based on the classification of the packet, available paths, and related path characteristics 418, a load balancer selects the best path for the new flow, and the best path is stored in the flow cache. In an embodiment, the load balancer is a part of the PBR engine 316. In an embodiment, a load balancer is external to the PBR engine. Next, at block 414, the packet is sent through an existing path from block 410 or a newly selected path from block 412 based on the contents of the flow cache, as discussed above.

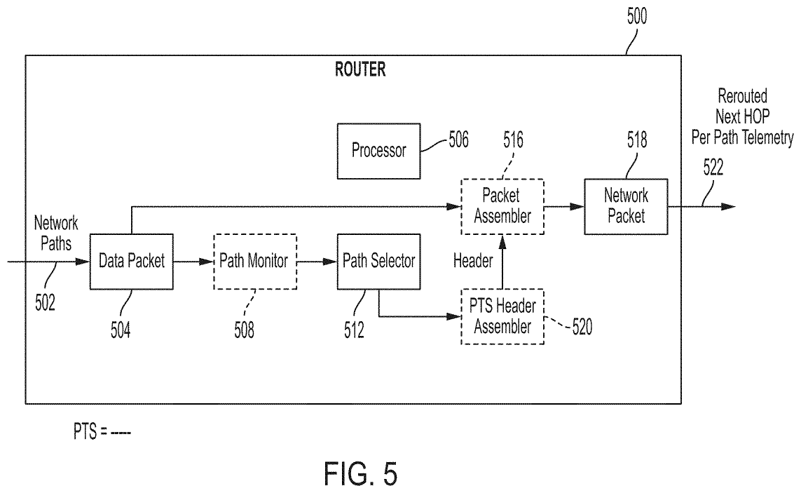

FIG. 5 is a block diagram of a router 500 that performs a path selection operation to determine the next path for a packet 504 through a network. In an embodiment, router 500 is an edge router, configured as router 300, in a WAN or public cloud, for example. This and further embodiments are suitable for use in a network in FIGS. 1-2, and other networks not shown or discussed herein. The dashed blocks shown in FIG. 5 are generally a part of a PTS engine, such as PTS engine 312.

In an embodiment, router 500 receives a packet 504 over a network path 502. Router 500 may receive data packets from multiple network paths via network path 502 for monitoring each network path. Router 500 has a processor 506, a path monitor 508, a path selector 512, a PTS header assembler 520, and a packet assembler 516. The various components in router 500 can be implemented using hardware, firmware, software executing on the processor 506, or combinations thereof. As earlier indicated, in an embodiment, path monitor 508, PTS header assembler 520, and packet assembler 516 may generally comprise a PTS engine, such as PTS engine 312. In an embodiment, path selector 512 may be a part of a PBR engine, such as PBR engine 316.

Packet 504 has a destination IP address and may have a service classification field in a header of the packet based on a corresponding application that is executing on the network. Path monitor 508 continuously monitors available network paths 502 and records corresponding path characteristics, as earlier discussed relative to PBR engine 316.

In an embodiment, monitored path characteristics are matched using a routing table to determine a destination IP address of the packet to determine a next hop, which may be a new hop depending on the path decision by path selector 512. In an embodiment, a router of the next hop decides a following hop based on its PBR engine. In an embodiment, router 500 decides the entire path of a packet, i.e., to a destination host, and intermediate routers do not alter the destined path. Traffic class may additionally be used as a basis for determining the next hop group. Next-hop groups list or otherwise point to IP addresses. For example, the routing table results map to a path in the network. Typically, tunnels are set up to define the path. MPLS is one tunnel encapsulation that can be used. In some embodiments, the next-hop groups or selected path define a forwarding equivalence class (FEC) for packets that are routed in a similar manner, as used in multiprotocol label switching (MPLS). The routing table is then used as a multiprotocol label switching map that maps IP addresses to next-hop groups. In an embodiment, the routing table and the path table are contained as a part of the same table.

A packet 504, received into the router 500, is to be routed onto a next path defined based on current network conditions. Path monitor 508 continuously monitors network paths 502. The path selection operation, performed by path selector 512, which is implemented using a forwarding information base in some embodiments, receives an extracted destination IP address from the header of packet 504, matches it to contents in a routing table, and, based on contents of the path table, replaces the contents of the routing table relevant to the IP addresses of the current path with a path that is selected in accordance with disclosed path selection methods. The selected path indicates the next path to which the packet should be routed. Some embodiments use a lookup table, in which an object name as an output of the table is looked up to provide an IP address or other identifier of the next path.

Path selector 512 matches the output of the routing table, which may be a part of the path selector 512, with a service classifier and generates the result of the match. If a match is found, path selector 512 outputs a selected path as a result of the match. PTS header assembler 520 generates a packet header with a structure that is further discussed relevant to subsequent figures. Network packet assembler 516 encapsulates the original packet, packet 504, with the header from PTS header assembler 520 to generate the network packet 518. network packet 518 is re-routed to a new path 522 in accordance with PTS path characterizations best suited for packet 504 to avoid bandwidth bottlenecks or otherwise improve application execution and load balancing. At a receiving end, the PTS header, encapsulating data packet 504, is stripped, and its contents are telling of various packet information, as will be discussed relative to a subsequent figure below.

In an embodiment, path selector 512 performs detection of path availability. For example, path monitor 508 may detect path activeness during each PBR session by continuously and periodically sending keepalive packets and expecting feedbacks on each PBR session. When a path is newly added by routing or configuration, it is initially considered inactive. An inactive path will not be considered for path selection by path selector 512. In an embodiment, router 500 will immediately start sending keepalive (KA) packets periodically via all PBR sessions of the path. Once feedback is received, the path for a corresponding class of traffic will be marked as active. Network traffic belonging to that PBR session will be allowed to flow through the active path from then on. A path is considered as inactive again for a PBR session if a no-feedback timer timeout occurs from the sender. If feedback is received for keepalive packets in any one of the PBR sessions, the path for the corresponding PBR session is marked as active again, which may be indicated in the original data packet 504 header.

In an example embodiment, a PBR session may be defined by a tuple, source IP (srcIP), destination IP (dstIP), PBRPort, where srcIP is a public IP address of the local path interface of the path the session is executing on and dstIP is the public IP address of the remote path interface, and PBRPort is the port number indicated in a PBR header (the original data header). A single path may be for one or more PBR sessions. For instance, instead of having one PBR session per path, one PBR session may be per class of traffic, with benefits such as tracking path characterization for different traffic classes over a path separately and flexibly applying different congestion control mechanisms over different classes of traffic over a single path.

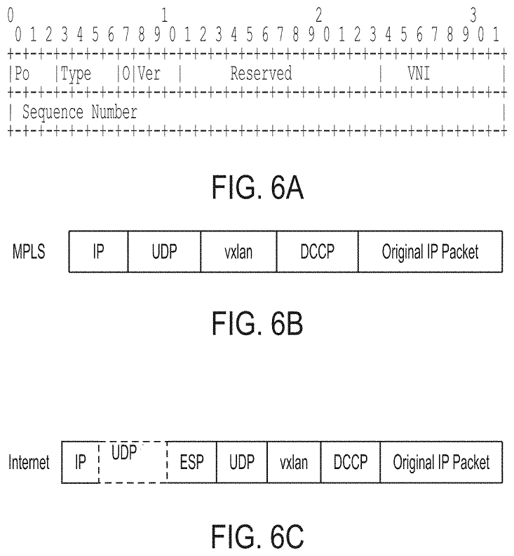

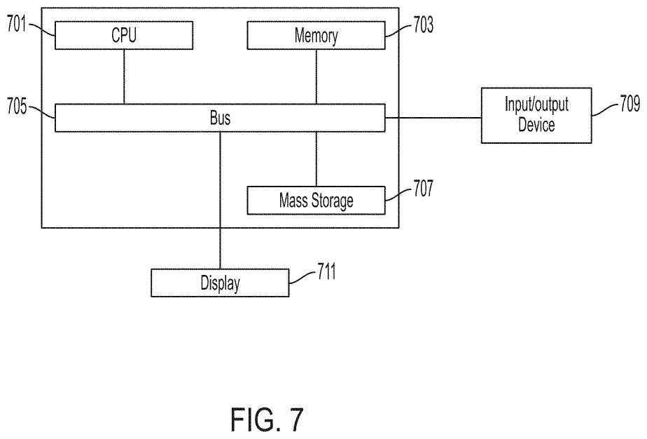

FIG. 6A shows an example PTS header structure with fields representing various information to the PTS module as defined below.

### Po[rt]:

Port number to identify PTS sessions along the same path. For example, 3 port bits defines 8 PTS sessions (one per class of traffic) per path.

### Type:

The Type field specifies the type of the packet. The following

4-bit Type field values may be defined as follows:

| Type | Meaning |
|---|---|
| 0 | PTS-Data |
| 1 | PTS-Ack |
| 2 | PTS-DataAck |
| 3 | PTS-Keepalive |
| 4 | PTS-Feedback |
| 5-15 | Reserved |

### O[ption]:

Indicates header has an option field.

### Ver:

Version number. For example, a three-bit version number supports up to 8 versions. Version number maintains upgrade consistency at remote networks.

### Reserved:

Reserved for future usage.

### VNI:

Virtual (local area network (VXLAN)) Network Identifier supporting several virtual networks based on the number of bits used for this field.

### Sequence Number:

The PTS engine uses sequence numbers to arrange packets into a sequence, to detect losses and network duplicates, and to protect against attackers, half-open connections, and the delivery of old packets. PTS sequence numbers are packet-based and, in an embodiment, start with a random number, and each PTS packet increments the sequence number by one. Accordingly, in the case of a missing packet, the sequence number does not match the expected number of packets. Packet loss (or drop) can, therefore, be determined. In other embodiments, sequence numbering may be assigned differently. For example, sequence numbers may begin with 0 or 1 instead of a random number.

In an embodiment, original data packets or original data packets and corresponding headers are encrypted prior to transmission and decrypted at the receiving end. In these embodiments, an encryption header field may be employed to indicate encryption and the type of encryption.

FIGS. 6B and 6C are examples of PTS header structures with encryption and without encryption, respectively. That is, in FIG. 6B, a PTS header example is implemented for MPLS with no encryption, whereas, in FIG. 6C, a PTS header example is implemented for the internet and includes encryption. Encryption is denoted by the “ESP” field in FIG. 6C. In both header structures, an IP field is followed by a user datagram protocol (UDP) field, which is followed by a VxLAN identification field, which is in turn followed by a datagram congestion control protocol (DCCP) field and the DCCP field is following by the original IP packet, for example, packet 504. An ESP field is inserted between the UDP field and IP and UDP fields in the internet header structure of FIG. 6C.

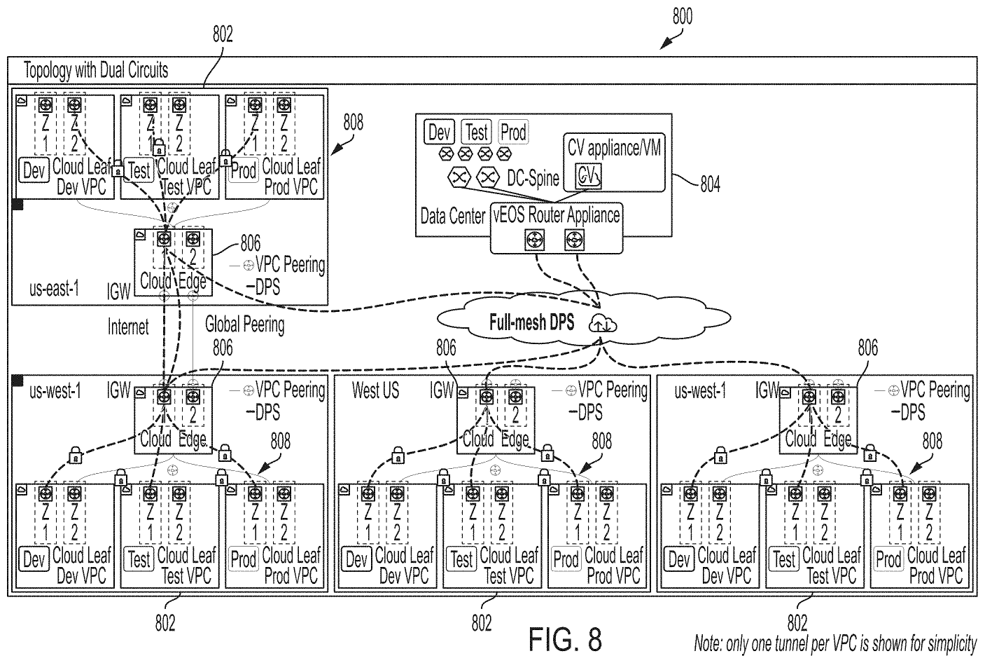

It should be appreciated that the methods described herein may be performed with a digital processing system, such as a conventional, general-purpose computer system. Special-purpose computers, which are designed or programmed to perform only one function, may be used in the alternative. FIG. 7 is an illustration showing an exemplary computing device that may implement the embodiments described herein. The computing device of FIG. 7 may be used to perform embodiments of the functionality for class-based network path characterization in accordance with some embodiments. The computing device includes a central processing unit (CPU) 701, which is coupled through a bus 705 to a memory 703 and mass storage device 707. Mass storage device 707 represents a persistent data storage device such as a floppy disc drive or a fixed disc drive, which may be local or remote in some embodiments. The mass storage device 707 could implement a backup storage in some embodiments. Memory 703 may include read-only memory, random access memory, etc. Applications resident on the computing device may be stored on or accessed via a computer-readable medium such as memory 703 or mass storage device 707 in some embodiments. Applications may also be in the form of modulated electronic signals accessed via a network modem or other network interface of the computing device. It should be appreciated that CPU 701 may be embodied in a general-purpose processor, a special-purpose processor, or a specially programmed logic device in some embodiments.

Display 711 is in communication with CPU 701, memory 703, and mass storage device 707, through bus 705. Display 711 is configured to display any visualization tools or reports associated with the system described herein. Input/output device 709 is coupled to bus 705 in order to communicate information in command selections to CPU 701. It should be appreciated that data to and from external devices may be communicated through the input/output device 709. CPU 701 can be defined to execute the functionality described herein to enable the functionality described with reference to FIGS. 1-6. The code embodying this functionality may be stored within memory 703 or mass storage device 707 for execution by a processor such as CPU 701 in some embodiments. The operating system on the computing device may be MS DOS™, MS-WINDOWS®, OS/2™, UNIX™, LINUX™, or other known operating systems. It should be appreciated that the embodiments described herein may also be integrated with a virtualized computing system that is implemented with physical computing resources.

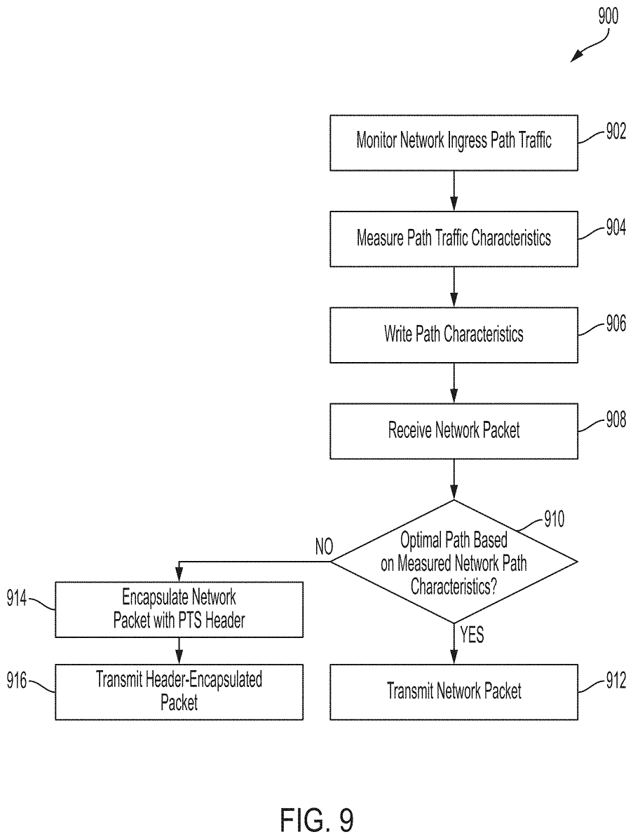

FIG. 8 shows a network configuration example application of disclosed path selection methods and embodiments. In FIG. 8, a network configuration 800 includes a combination of networks 802 configured to be in remote communication with data center 804. Exemplary networks include a Microsoft Azure network, a Google cloud network, and an Amazon AWS network. Each network 802 includes an edge router 806 and a set of subnets 808. Each router 806 monitors network paths and implements network path performance measures that facilitate network performance awareness, load balancing, application execution improvement, bandwidth bottleneck prevention, and traffic congestion avoidance. It is understood that any number or type of network equipment and any combination thereof other than those shown in FIG. 8 may be employed.

A practical example of the application of FIG. 8 is to BankA with headquarters located in Nebraska and branches located in California. Two of BankA's California branches may each implement an AWS network, and the BankA headquarters may implement an Azure network. Headquarter and branch network traffic can travel through the internet and global peering. Path selection is made dynamically by a corresponding edge router 806 of each of these networks, which continuously monitors corresponding ingress network traffic and. based on a best-path determination, decides the most efficient or packet loss-proof path to choose, in accordance with disclosed methods. Additionally, each router 806 can monitor inter-network traffic through local subnets 808 and dynamically decide its priority, for example, based on critical versus non-critical traffic criteria. Accordingly, because edge routers of each network are continuously monitoring network paths, they are network path status- and health-aware and facilitate selection of paths based on optimization performance costs.

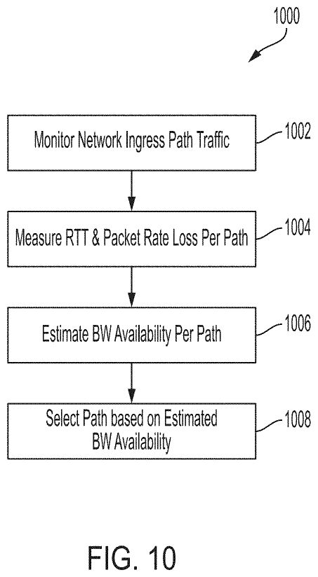

FIG. 9 is a flow diagram of a method, such as a process 900, for network path selection, which can be practiced by embodiments of the networks and routers shown in FIGS. 1-8. In an embodiment, the flow diagram of FIG. 9 describes a process performed by an edge router. In some embodiments, the method can be performed by software executing on a processor, and in some embodiments, the method is further performed using a content-addressable memory. In an embodiment, the steps and determinations shown in FIG. 9 are performed by a network router, such as, without limitation, router 300. By way of example only, the flow diagram of FIG. 9 is discussed below, relative to router 300 of FIG. 3.

At process 900, block 902, ingress traffic is monitored by PTS engine 312. Next, at block 904, while monitoring network traffic, PTS engine 312 maintains path characterization measurements and calculation results in a path table, such as path table 314. Path table 314 maintains measurements and calculation results performed for all available paths that incoming data packets can possibly travel to get to their destination, as denoted at block 906 at block 908. When a data packet is received, at, for example, interface 302, a decision is made, at decision block 910, as to whether the received data block is traveling an optimized path or at least a path with no foreseen bandwidth bottlenecks. To this end, at block 904, PTS engine 312 measures RTT and packet loss rates, for example, using the TCP performance model discussed herein, for all available paths. If at block 910, PBR engine 316, in determining the best path, predicts bandwidth limitations (bottleneck), at block 914, PTS engine 312 is directed to implement encapsulation of the original data packet with a PTS header, such as those earlier discussed, relative to MPLS and internet, for example. PTS engine 312, upon completion of encapsulation, transmits the header-encapsulated packet at block 916. Otherwise, no change is made to the original packet, i.e., PTS header is not made to encapsulate the original packet, and the original packet is transmitted at block 912.

FIG. 10 is a flow diagram of an example telemetry method, such as a process 1000, for network path selection, which can be practiced by embodiments of the networks and routers shown in FIGS. 1-8. In an embodiment, the flow diagram of FIG. 10 describes a process performed by an edge router. In some embodiments, the method can be performed by software executing on a processor, and in some embodiments, the method is further performed using a content addressable memory. In an embodiment, the steps and determinations shown in FIG. 10 are performed by a network router, such as, without limitation, router 300. By way of example only, the flow diagram of FIG. 10 is discussed below relative to router 300 of FIG. 3.

At block 1002, network ingress path traffic is monitored by PTS engine 312. Next, at block 1004, PTS engine 312 measures RTT and packet rate loss for each monitored path, and PBR engine 316 calculates bandwidth availability for each path based on the measured RTT retrieved from path table 314. Next, at block 1006, PBR engine 316 estimates the bandwidth availability for each path based on the corresponding measured RTT and continues to block 1008. At block 1008, PBR engine 316 selects the best path based on the bandwidth availability estimation at block 1006. It is understood that one or more other criteria or a combination of criteria, such as WRR and class traffic, jitter, and latency may be implemented to determine a best path, as earlier discussed.

It will be apparent to those of ordinary skill in the art that methods involved in the present invention may be embodied in a computer program product that includes a computer-usable and/or -readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

What is claimed is:

1. A method of path selection in a network comprising:
receiving a data packet, at a router, the data packet including a header indicating a current path through which the data packet is destined to travel to reach a destination router of the network;
at the router, determining whether the current path is a best path among a set of paths of network paths for the data packet to travel through to reach the destination router based on telemetry characteristics of the set of paths and the current path, wherein the telemetry characteristics include a bandwidth availability estimate that is a function of one or both of a corresponding path throughput and a corresponding path packet loss rate; and
at the router, in response to determining the current path is not a best path among the set of paths for the data packet to travel through to reach the destination router, selecting the best path of the set of paths based on the telemetry characteristics of the set of paths, wherein the best path of the set of paths replaces the current path that the data packet is destined to travel to reach the destination router.

2. The method of claim 1, further comprising monitoring the set of paths for measuring the telemetry characteristics of the set of paths and for comparison with measured telemetry characteristics of the current path.

3. The method of claim 2, further comprising maintaining monitored telemetry characteristics for at least some of the paths of the set of paths in a path table of the router.

4. The method of claim 2, wherein telemetry characteristics of at least some of the monitored paths are measured in real time.

5. The method of claim 2, wherein monitored telemetry characteristics of the set of paths correspond to one or more of a selection of: a corresponding path latency, a corresponding path jitter, and a corresponding path packet loss.

6. The method of claim 1, further comprising in response to selecting the best path, transmitting the data packet through an egress interface of the network to the destination router.

7. The method of claim 1, further comprising in response to selecting the best path, encapsulating the data packet with a path telemetry and shaping (PTS) header indicative of the best path.

8. The method of claim 7, further comprising transmitting the encapsulated data packet through an egress interface of the network to the destination router.

9. The method of claim 1, wherein the set of paths includes all available paths of the network that the data packet can travel to reach the destination router.

10. The method of claim 1, wherein the bandwidth availability estimate for each path of the set of paths is based on a transmission control protocol (TCP) performance model.

11. The method of claim 10, wherein the TCP performance model is based on in-band network path telemetry.

12. The method of claim 1, wherein selecting the best path from the set of paths is further based on a class of traffic of the network.

13. The method of claim 1, wherein in response to determining the current path is a best path, transmitting the data packet through the current path to reach the destination router.

14. A router of a network comprising:
a policy-based routing (PBR) engine configured to receive a data packet including a header indicating a current path through which the data packet is destined to travel to reach a destination router of the network; and
a path telemetry and shaping (PTS) engine configured to determine whether the current path is a best path among a set of paths of network paths for the data packet to travel through to reach the destination router based on telemetry characteristics of the set of paths and the current path, wherein the telemetry characteristics include a bandwidth availability estimate that is a function of one or both of a corresponding path throughput and a corresponding path packet loss rate,
wherein in response to determining the current path is not a best path among the set of paths for the data packet to travel through to reach the destination router, the PTS engine is configured to select the best path of the set of paths based on the telemetry characteristics of the set of paths, wherein the best path of the set of paths replaces the current path that the data packet is destined to travel to reach the destination router.

15. The router of claim 14, wherein the PBR engine is configured to monitor the set of paths to measure the telemetry characteristics of the set of paths and for comparison with monitored telemetry characteristics of the current path.

16. The router of claim 15, wherein monitored telemetry characteristics of at least some of the paths of the set of paths are maintained in a path table.

17. The router of claim 15, wherein the PBR engine is configured to monitor at least some of the telemetry characteristics in real time.

18. The router of claim 15, wherein monitored telemetry characteristics of the set of paths correspond to one or more of a selection of a corresponding path latency, a corresponding path jitter, and a corresponding path packet loss.

19. The router of claim 14, wherein in response to the PTS engine selecting the best path, the router is configured to transmit the data packet through an egress interface of the network to the destination router.

20. The router of claim 14, wherein in response to selecting the best path, the PTS engine is further configured to encapsulate the data packet with a path telemetry and shaping (PTS) header indicative of the best path.

21. The router of claim 20, wherein the PTS engine, in response to encapsulating the data packet with a PTS header, is further configured to transmit the encapsulated data packet through an egress interface of the network to the destination router.

22. The router of claim 14, wherein the set of paths includes all available paths of the network that the data packet can travel to reach the destination router.

23. The router of claim 14, wherein the bandwidth availability estimate for each path of the set of paths is based on a transmission control protocol (TCP) performance model.

24. The router of claim 23, wherein the TCP performance model is based on in-band network path telemetry.

25. The router of claim 14, wherein the PBR engine is configured to select the best path from the set of paths based on a class of traffic of the network.

26. The router of claim 14, wherein the PTS engine, in response to determining the current path is a best path, is configured to transmit the data packet through the current path to reach the destination router.
